(19) United States
(12) Patent Application Publication
(10) Pub. No.: US 2024/0103190 A1
(43) Pub. Date: Mar. 28, 2024

(54) Time-resolved Radiation Dose and Health Mapping in Extreme Environments

(71) Applicant: GOLD STANDARD RADIATION DETECTION, INc., Albuquerque, NM (US)

(72) Inventor: Mark Derzon, Albuquerque, NM (US)

(21) Appl. No.: 18/263,958

(22) PCT Filed: Oct. 27, 2021
(86) PCT No.: PCT/US21/56814

§ 371 Date: Aug. 2, 2023

Related U.S. Application Data
(60) Provisional application No. 63/106,693, filed on Oct. 28, 2020.

(51) Int. Cl. G01T 7/12; G01T 1/02; G01T 1/175

(52) U.S. Cl. CPC G01T 7/12; G01T 1/02; G01T 1/175; H04L 67/12

(57) ABSTRACT

The present invention provides the components and system for a self-assembling hardened network which will function without other infrastructure by creating a time-evolving map of the radiation dose and doserate. Other environmental sensors for additional purposes can be added to it. The network offers simple electronic applications able to be run on a hand held electronic device, with base station or booster elements and/or, the cell network in conjunction with a radiation detector to provide stay time and health hazard decision making support to individuals in unknown or varying radiation fields. This capability will survive prompt and fallout features of nuclear disasters, as well as other environmental issues or threats. This will be useful information when other public services are unavailable, and police and fire are overwhelmed.

### FIELD OF THE INVENTION

The invention is in the field of radiation sensing, specifically in the field of radiation field mapping and display for health effects, dose, and dose rate in harsh environments such as intense radiation, EMP environments and GPS-denied environments.

### BACKGROUND

Radiation has no color or smell. It can give us delayed health effects, or a lethal dose accompanied by a horrible death. This can happen while you can have no immediate knowledge that you were exposed. Exposure can be due to from a Radiation Dispersal Device (RDD), an accident like Chernobyl, or a nuclear detonation. There can also be a moving cloud of radiation.

In the case of a large area event such as a nuclear weapon accident, terror, or war, then services such as internet, cell phones, and military support might be unavailable or overworked. Global Positioning System (GPS) service will likely be denied as well. If a radiation detection application does not reside on a communication system that is robust enough to survive then the application, by itself, is relatively useless. It can even cause harm because users will be wasting precious time on something not working. This makes the issues of the network become a subset of what could be considered radiation decision support of key import.

The cell phone network can be disabled by many mechanisms including terrorist acts. See, e.g., Report of the Commission to Assess the Threat to the United States from Electromagnetic Attack′, http://www.empcommission.org/docs/A2473-EMP Commission-7 MB.pdf; Electromagnetic Pulse Threats to America's Electric Grid: Counterpoints to Electric Power Research Institute Positions, https://othjournal.com/2019/08/27/electromagnetic-pulse-threats-to-americas-electric-grid-counterpoints-to-electric-power-research-institute-positions/, and references therein; “Electromagnetic Pulse (EMP) Following Detonation of an IND’, Radiation Emergency Medical Management, 2019 https://www.remm.nlm.gov/EMP.htm, ′, Quote: ‘Although experts have not achieved consensus on expected impacts, generally they believe that the most severe consequence of the pulse would not travel beyond about 2 miles (3.2 km) to 5 miles (8 km) from a ground level 10 KT IND detonation.’ Any nuclear explosion is accompanied by an EMP, which travels farther than the radiation from the bomb, and is capable of disabling cellular infrastructure for hours to days. At some spatial distance well away from the location of the disaster they will work but will be less useful. We illustrate the distance effects in FIG. 1. In the figure, we show an illustration of a nuclear event in New York (it could have been a battlefield in the Middle East or China). The figure shows a rough idea of what the radiation dose and fallout may look like in the colored regions. The cell network will likely fail inside the dashed curve and the distance are variables depending on location of device, yield and other variables. Depending on the device, and where is goes off, the radius could be much larger. Some of the equipment inside the curve may survive but it is likely that a few hours or days will pass before software on a phone will be useful. It is also likely that GPS will not be working. Almost all articles discussing the hazards of fallout and nuclear radiation ultimately have an image of how the threat is dispersed and may change with time. Obtaining an image of the time-resolved hazard is very important.

Processors can fail by giving wrong answers to calculations at doses as low as 10 mrad. This is the reason airplanes employ multiple processors doing consensus calculations, meaning running the same code on multiple processors, and when one starts deviating inflight it is shut down and restarted. Even at relatively low dose rates most processors will need to be reset every few hours if exposed to even 10 mrad/hr due to single event upsets.

A look at a modified version of the historic plot from Glasstone and Dolan, FIG. 8.14, 1977 edition, see FIG. 2, provides some insight into dose rate effects. The figure has four traces. The first two traces we discuss are gamma dose emission rate versus time for a fissioning mass (green diamonds) and for a high-altitude blast (red circles). They show that the initial or prompt burst of radiation is roughly 11-orders of magnitude greater than the rate at 1 hour. That is a huge difference. We also show the dose in the curves from fission (black x's) and air burst (blue squares). All the traces are normalized to the value one because of the relative effects that are important to this discussion. The hardware is known to have problems at high dose rates and total dose. People tend to be sensitive to the total dose. It can be important to the hardware, but rarely will it be important to health whether the event was at high altitude or near the ground. The annotated section in the upper left points out that nothing currently on the market is unsaturated above that dashed line (that they don't work) because of the detector electronics. In about the middle are some notes that the circuits for processing the data are failing and near the bottom the line shows where the numerical processors are beginning to fail due to single event upsets. Notice that at approximately 4000 sec the dose curves are very close together. Please note that the scaling here only emphasized the fission-alone types of devices. Device design and location can emphasize prompt versus delayed effects.

Around the world, billions of dollars have been invested in making radiation hardened processors and components. Those are typically designed for space based applications where total doses are high—much higher than the lethal dose of radiation, however that does not mean they are designed for these high bursts of radiation. Because of this those in the field need to be aware that radiation hardening is not the same thing in all situations and what one uses for one situation will likely fail in another if attention is not paid to the differences.

If one were to get 100 mrad of dose after 1 hour (note that this is a radiation worker's yearly occupational limit) from a fission device then the peak dose rate would be about 1e10¹⁰ rads/hour or 3×10⁶ rads/second. This would not destroy most electronics; however most processors would need a reset. This is a key amount of dose because it would register in the software we will describe for occupational exposure. With this dose the average cell phone has a high likelihood of not working properly without a reboot. This late time acquired dose rate over a long time is the likely cause of most of the long-term deaths from the Chernobyl accident.

If a person were unfortunately in a zone obtaining 400 rad in 15 minutes (Lethal dose 50/30) then the peak dose rate would have been approximately 4×10¹³ rads/s. Most electronics will likely fail permanently if operational and fully powered. Many electronics can survive if powered down during the high dose period.

Prompt radiation is considered anything from 100 nanoseconds to an hour after an event. For this discussion anything less than 15 min. is ‘prompt’ for the simple reason is that it roughly how long it might take an individual to pull out a personal electronic device, check the results, and act. That kind of environment would likely also be high EMP, radiation damaged electronics and GPS-denied.

Garwin suggests ‘60,000 people would be dead from prompt effects and 1 million people could be evacuated’. Garwin R. L. 2010. Nuclear Terrorism: A Global Threat. Presentation at the Harvard-Tsinghua Workshop on Nuclear Policies, Beijing, China, Mar. 16, 2010. Available online at http://bit.ly/bOPCma, The Bridge, https://www.nae.edu/File.aspx?id=20575, suggests 60,000 people would be dead from prompt effects and 1 million people could be evacuated. Original source 2006 RAND paper for DHS. Enav, and others not referenced point to potentially 20× [from 1M/60,000] reduction in deaths. Einav, S., et al, Evacuation Priorities in mass casualty terror-related events, Ann Surg, 239(3), 304-310. Evans, et al, ‘Health Effects Model for Nuclear Power Plant Accident Consequence Analysis’, 1993. This large potential reduction in consequences is an important benefit of certain embodiments of the present invention.

### SUMMARY OF THE INVENTION

The prior discussion articulated how a map of the radiation field and hazards presented is intimately tied into the display concepts and networking. Embodiments of the present invention provide at-a-glance displays and networking systems to provide real time information regarding the time varying radiation field. The invention can be extended to other hazards as well, such as a moving toxic clouds or EMP such as that which was created in the Beirut port explosion. Embodiments of the invention can also provide radiation hardening and EMP-hardening systems and can couple to a hardened network using some of the same techniques. The display and data access will then reside on existing platforms as well as hardened ones through a radiation- and EMP-hardened Long Range (LoRa) network (this refers to any kind of long-range network not just a low bandwidth LoRa-wan or LoRa commercial units, other Internet-of-Things are also included) with a locator that works in GPS-denied situations.

Embodiments of the present invention address two of the issues presented in the background material. The first is the provision of at-a-glance displays and mapping to present results; and the second is provision of features and design a of a network that operates in an intense radiation environment, which is also an EMP environment and GPS denied. In addition to the EMP pulse, the radiation itself can cause the phone or other display to fail. T. F. Wrobel, J. L. Azarewicz, “HighDose Rate Burnout in Silicon Epitaxial Transistors”, IEEE Nuc. Sci., NS-27, December, 1980. Ohring, M., ‘Reliability and Failure of Electronic Materials and Devices’, Academic Press, 1998. When powered, electronic chips can fail at dose rates as low as 3×10₁₀ rad/s. The electronics can fail permanently at those dose rates or, perhaps worse, can fail to operate properly. An electronic system that is off during irradiation is much more robust than one that is powered. When there is a way to rapidly shut off a circuit during a rising dose rate then the circuit is more far more likely to work after restart. Embodiments of the present invention provide a built-in circuit to do just that, e.g., including those described in U.S. provisional 62/734,238 filed Sep. 20, 2018, and PCT/US2020/024147, filed Mar. 23, 2020, each of which is incorporated herein by reference.

Embodiments of this invention include a multiplatform, radiation and EMP hardened electronics board that includes multiple sensors to cover the range of threats that may be encountered in a nuclear o, chemical, radiation, EMP or explosive threat envelop. Embodiments provide a board/assembly/device that is protected. This network preferentially is able to be shut down during an event and restart after. See FIG. 3A as an illustration of a multipurpose board described (it has power control, processing, readout, and RADFET sensor (far side). FIG. 3b is a process flow of a board embodiment. In addition, it should be able to start up and have the nodes of the network assemble and share information. Once assembled it is desirable to be able to display the results of the health software superimposed on a time-evolving map. We illustrate an example embodiment in FIG. 5. FIG. 5 shows a handheld device with a graphic illustrating an at a-glance comparison of the current dose and the health effect of that dose with respect to occupation requirements on the top of the display. In the middle is a graphical and numerical display of the time until the next occupational limit and health marker. On the bottom is a local area map with a listing of health parameters or dose or dose rate (user's choice) superimposed. The color shaded regions illustrate how a fallout pattern might be reflected in the impromptu measured radiation map.

The discussion above describes a software application residing on a network with electronics that is EMP hard, radiation hard, and operates in a GPS denied environment and/or uses other location technology (e.g., a compass) for both prompt and delayed radiation. The solution can include a phone or other display on a network that comes up soon after the EMP and that can survive the EMP pulse.

### BRIEF DESCRIPTION OF DRAWINGS

The accompanying drawings show aspects of the specification and practice of potential embodiments of the invention. They are meant to illustrate embodiments and serve as examples. They are not meant to limit the invention.

FIG. 1. Illustration of an area surrounding a low yield nuclear device, radiation dispersal, reactor incident or other radiation dispersal event. Dashed line represents the lower limit of the EMP damage. It is expected that the cell network will not be working inside the dashed line for hours or days. Stars represent working sensors. The colored shaded region represents the fallout ‘ground-truth’ and will not appear in the app. Color coded or size coded points or stars will overlay on the map to provide a time resolved spatial idea of the health hazards and thereby guidance on how to avoid hazardous regions or to travel between points on the map.

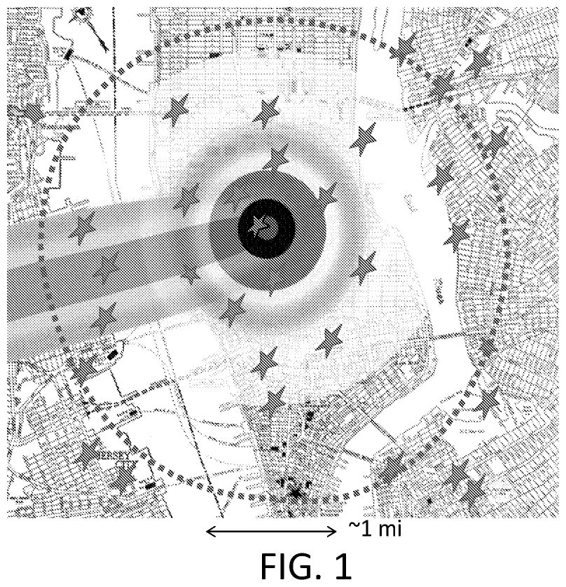

FIG. 2. Dose and Dose After Nuclear Explosion. Modified version of FIG. 8., from Glasstone and Dolan, 1977. The figure shows a rough idea of what the radiation dose and fallout might look like in the colored regions of the previous map. The cell network will likely fail inside the dashed curve. Depending on the device, and where is goes off, the radius could be much larger. Some of the equipment inside the curve may survive but it is likely that a few hours or days will pass before software on a phone will be useful. It is also likely that GPS will not be working. The figure has four traces. The first two traces we discuss are gamma dose emission rate versus time for a fissioning mass (green diamonds) and for a high-altitude blast (red circles). They show that the initial or prompt burst of radiation is roughly 11-orders of magnitude greater than the rate at 1 hour. That is a huge difference. We also show the dose in the curves from fission (black x's) and air burst (blue squares). All the traces are normalized to the value one because it the relative effects that are important to this discussion. The hardware is known to have problems at high dose rates and total dose. People tend to be sensitive to the total dose. It may be important to the hardware, but rarely will it be important to health whether the event was at high altitude or near the ground. Notice that at approximately 4000 sec the dose curves are very close together. The location of Lethal Dose to 50% of people at 30 days is marked on the image. In addition, the current value of saturation for all competitive real-time sensors is shown. The value represents this technology offering almost three orders of magnitude improvement over existing commercial products in terms of the average to peak saturation levels. The board offers some protection against both dose rate and absolute dose limitations in typical electronics. Note that space-based radiation hardening conditions are more based on total dose at lower rates than the solutions described here which are more for high dose rate situations. The flow diagram also shows how the circuit can contain elements for protection against high EMP pulses as well as radiation. This figure illustrates multiple key uniqueness features of this invention.

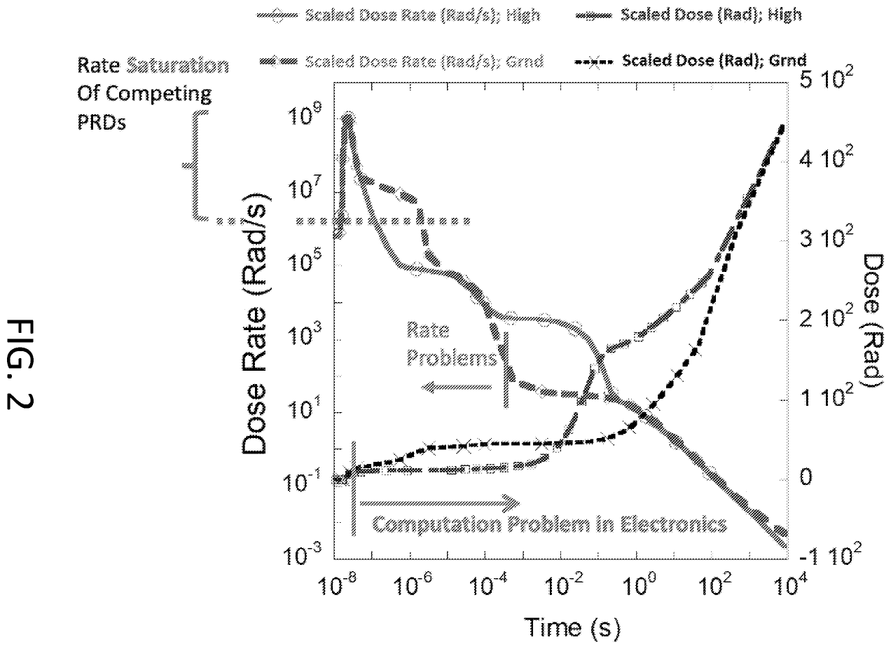

FIG. 3A Top is a representation of a board holding multiple radiation sensors. RADFETs or other devices to handle high dose and capable of integrating the radiation while the unit is powered down. It interfaces through an electronic port as well as a EMP hardened LoRa network port. It accepts regulated power, or it takes a power-on signal from an electro-optical switch to be used to isolate and then accept power from an on-board battery. The board can be mounted into multiple platforms, as in FIG. 3A bottom, (such as an integrated sensor, a computer, radar or other system it is meant to be modular, it can serve as a sensor or as a radiation based switch to shut down or reboot electronics at as a function of either dose rate or dose.

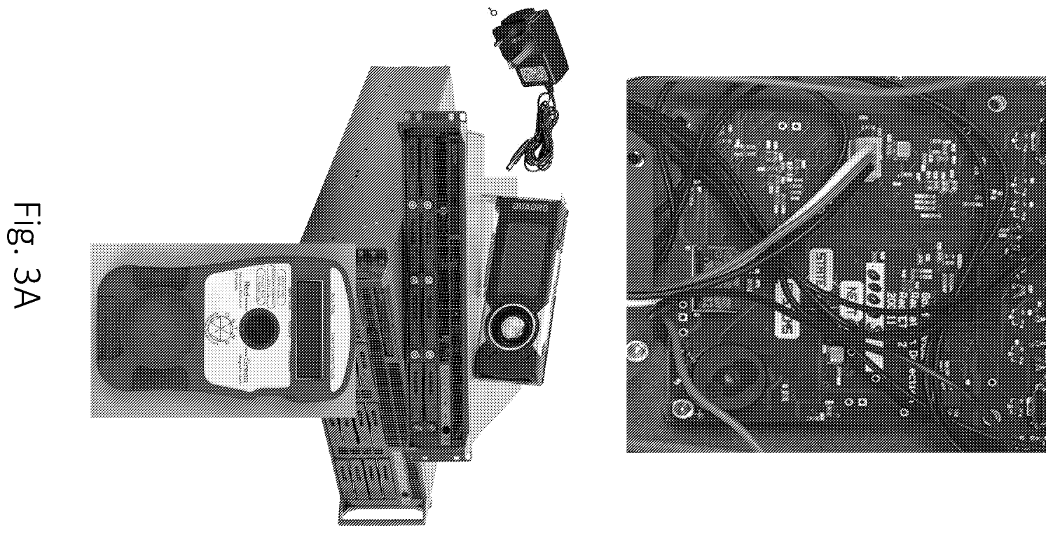

FIG. 3B. Process flow chart which as one embodiment can be implemented on a board similar to that of FIG. 3A.

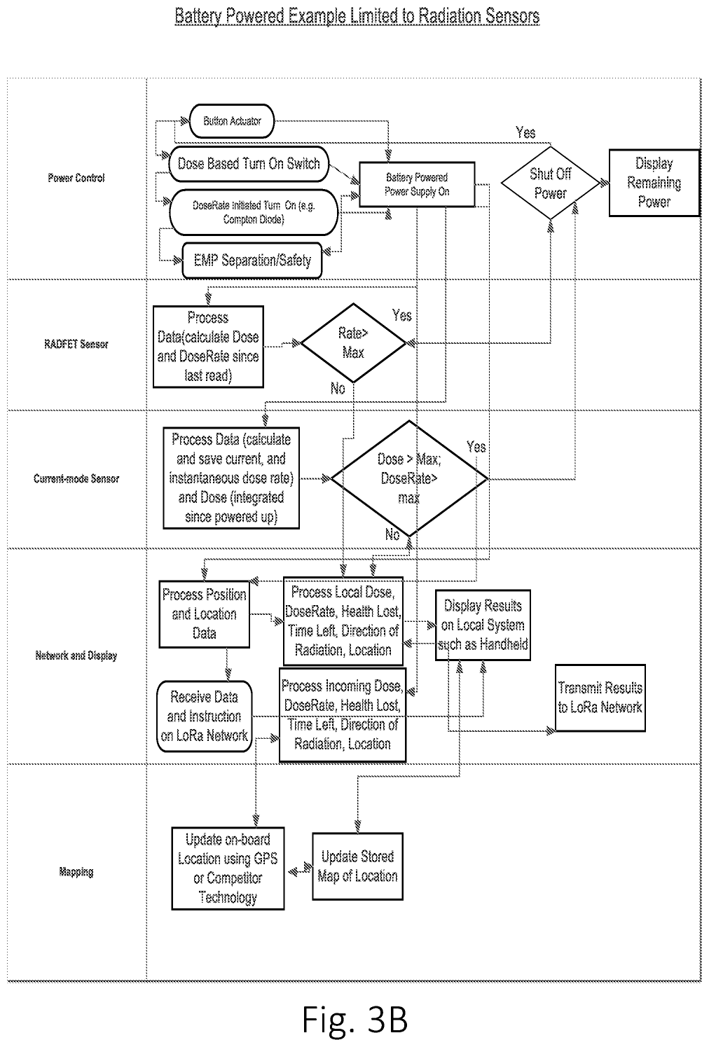

FIG. 4 is an illustration of a block diagram of components for a simple board level configuration which can be used in many types of configurations.

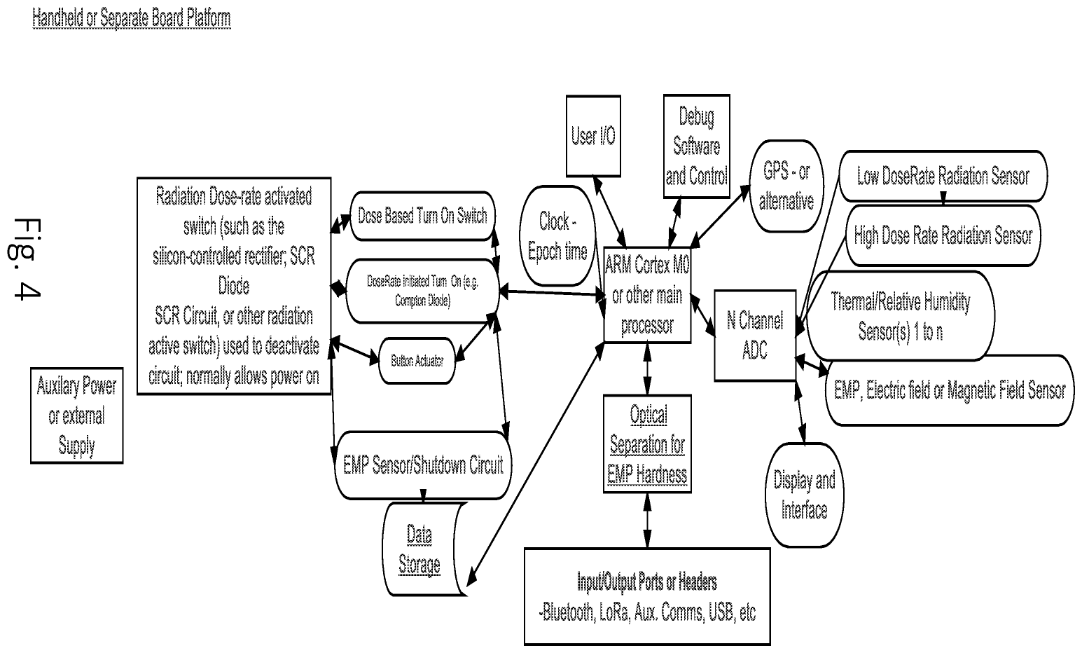

FIG. 5 shows an example Cell phone or handheld display containing three key concepts of the invention. These include an at-a-glance pictograph of the Health Lost status vs health status markers or Occupational limits. Displays both health and occupational limits at-a-glance on top. Below is a pictograph showing how much until the next occupational or health limit. The bottom shows a local map with health effects and dose superimposed. The map of health effects is made up of pixellated points from active sensors. At a glance pictograph of the stay time available prior to meeting Health Lost status vs health status markers or Occupational limits. The order and specifics of each pictograph are not meant to be limiting features but examples of the displays.

FIG. 6. Expanded view of option for the at a glance health and occupational limit pictographs.

FIG. 7. Expanded view of additional options for the time left until meeting occupational limits as well as LD 50/30. An alternative to FIG. 6 in either color or black and white/greyscale, these are single bar graph representations of both the health left and the amount of time available at the current doserate. These are meant to be even simpler representations of the health lost and time left than the earlier at-a-glance displays. Either representation may be more effective, depending on the application. The text accompanying each pictograph will vary as per the pertinent health effect or occupation rate as was shown in FIGS. 6 and 7.

FIG. 8. Taken from the NRC website. FIG. 8 is an overlay of the dose effects of radiation on regulatory control. The NRC website health effects as a function of dose and organizational requirements. We show this as an example of radiation dose compared to organizational requirements. Embodiments of the invention will allow users to compare the health effects versus the dose for multiple organization in a clear and quick manner. This is a type of information to be coded into the pictographs.

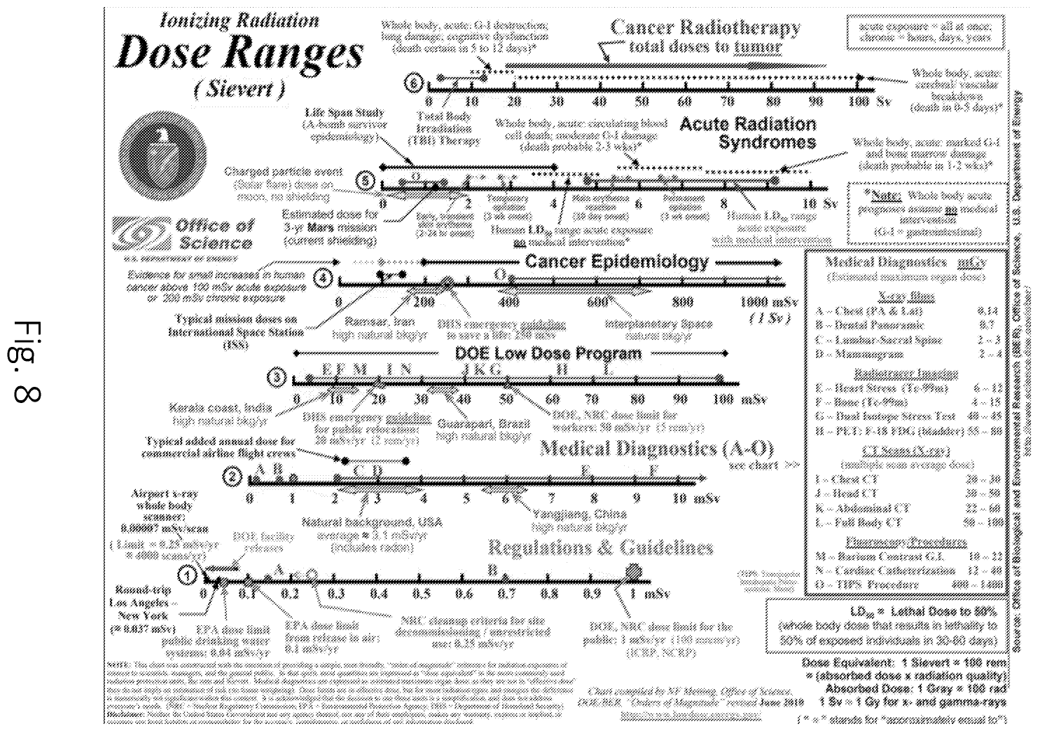

### DETAILED DESCRIPTION OF INVENTION

Embodiments of the present invention provide one or more of the following.

Software residing on multiple platforms that displays at-a-glance views of radiation health effects. Updates from the network allow the map to be displayed on hardened nodes and whatever cell phones nearby are operating and have the ability to communicate with the LoRa network.

The at-a-glance views display the radiation time available until next occupational health marker is reached as well as health markers. Software residing on multiple platforms that displays at-a-glance views of real time, or time evolving, maps of health or ‘stay time’ effects are reached.

Software residing on multiple platforms that displays at-a-glance views of real time weather (prevailing wind or rain) which can affect radiation dose and dose rate patterns.

Software fitted to sensor points that attempts to extrapolate radiation dose effects to create patterns of dose and dose rate in real time by smoothing the point generated map. Examples include quadratic or cubic spline fits to create dose sheet or dose rate sheet estimates.

A platform that is expandable to illustrate other hazards such as EMP, fire, chemical residue, bioagents, etc. as the sensors become available.

Embodiments of the invention include an at-a-glance pictographs for health and dose evolving features at the point of a sensor.

Embodiments include a hardware configuration that can survive in harsh ionizing radiation, EMP, and GPS-denied situations. We use the term hardened to reflect with respect to harsh ionizing radiation, EMP, and GPS denied environments. This includes protocols for sharing information between hardened and unhardened nodes.

Protocols and hardware for shutting down network nodes in the presence of ionizing radiation, or EMP and restarting the equipment and network capability enabling the network to survive and restart operation and self-assemble to allow new nodes to be added to the network as they become available. An example of a dose-rate trigger switch is the silicon-controlled rectifier (SCR). Other examples are a radiation-induced conductor (RIC, an example of this is a semiconductor operated near the avalanche regime) or a gas/vacuum switch. We can also use a dose-based switch, this will allow the circuit designer to clear out single event upsets when needed. It might not be as robust a process as a consensus-based processor network, but much less power and expense will be required.

Survival in certain harsh environments (such as radiation) mean the network should sense the radiation field and shut down if dose rates become too high, or EMP is large. The network should have survivable memory and a mechanism to restart once the hazard is reduced. after the threat to operation has passed. These features are included in example embodiments.

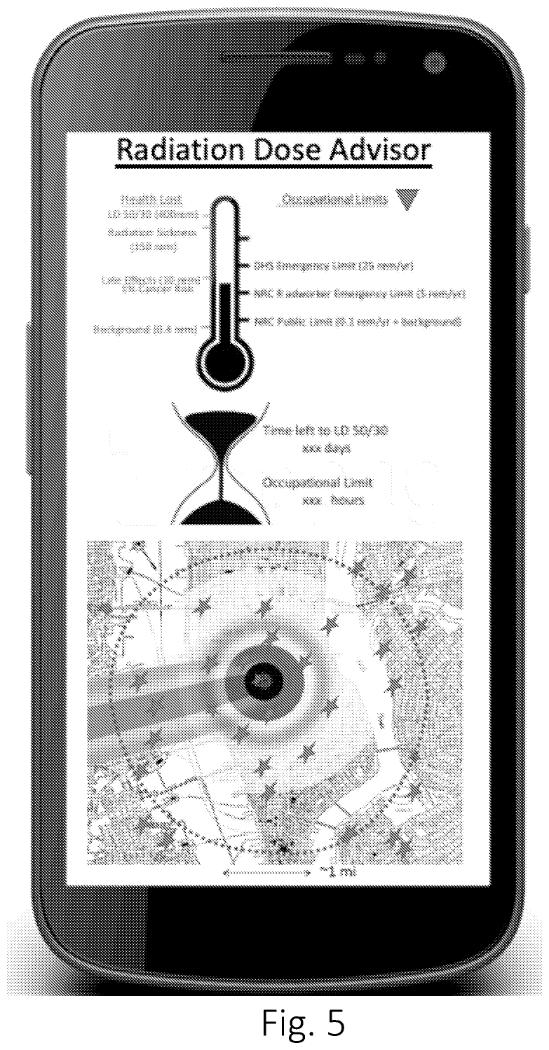

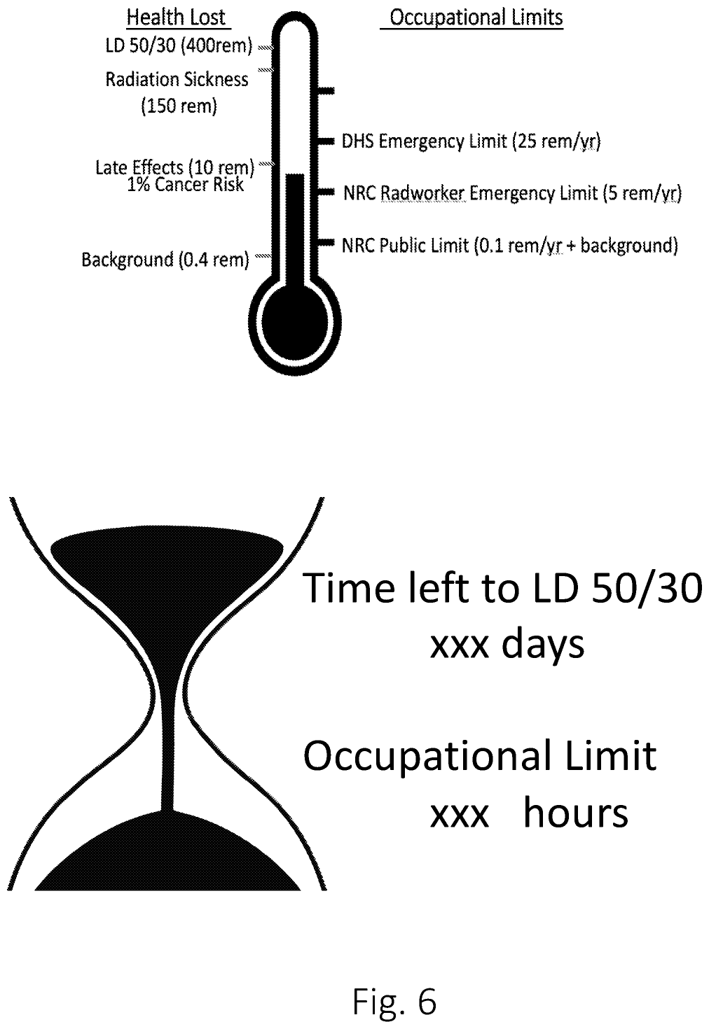

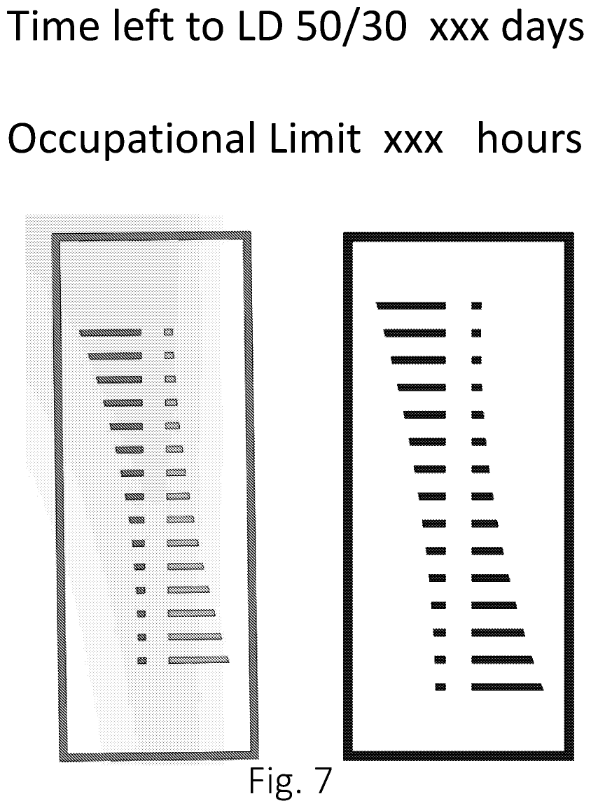

This network should be able to be shut down during an event and restart after the event. In addition, it should be able to start up and have the nodes of the network assemble and share information. Once assembled they should be able to display the results of the health advisor superimposed on a time-evolving map, e.g., as illustrated in FIGS. 5-7. On the bottom of FIG. 5 is shown a local area map with a listing of health parameters or dose or dose rate (user's choice) superimposed. The color shaded regions illustrate how a fallout pattern can be reflected in the impromptu measured radiation map expanded graphic illustrating an at a-glance comparison of the current dose, with respect to the health effect of that dose with respect to occupation requirements on the top of the display. In the middle is a graphical and numerical display of the time until the next occupational limit and health marker. Both the hourglass and thermometer icons are only meant to represent examples of two different local features—an immediate sense for how much dose has been acquired and a real time indication of how much time is left before reaching the next health marker or occupational limit.

In FIG. 5, the yellow and red color in the figure is an illustration of the ‘fallout’ pattern and dose. Each point would be a sensor and the image of the ‘fallout’ would be represented by the color of each point which represents one sensor. Color stars represent cell phones, or rad-hard networked sensor. The device corresponding to the red star stopped working.

Example embodiments provide a health advisor software application residing on a network with electronics that is EMP hard, radiation hard, and operating in a GPS denied environment for both prompt and delayed radiation. Example embodiments can include a phone or other display on a network that comes up soon after the EMP and that can survive the EMP pulse. Embodiments of the invention provide or make use of a LoRa network. A LoRa network can have nodes (e.g., each sensor point) and repeaters (e.g., base stations) to extend and modify the distance the signal transmits. An example network design comprises nodes or points which house a display for each user and potentially sensors. The sensors can be point sensors (they measure just dose and/or dose rate) or more complex devices which provide functions such as imaging, radiation direction, or spectroscopy.

Each node can provide short bursts of output through known LoRa protocols that can be read by other nodes and central stations whose purpose is to resend and amplify the signals over greater distances. As the information from each node is collected by other nodes (the distributed network) each node is collecting the application information. Cell phones can be added as nodes on the network as cell phones can add adapters to read LoRa results and the repeaters can be designed to accept signals from any operating cell phones in proximity.

An example of the process follows. If a sensor reports a whole-body dose of 150 mrem (1500 uSv) a look-up-table indicates that the DOE limits for a radiation worker for that year were exceeded. Alternatively, if Army personnel over the age of 18 were to receive that amount in the course of an emergency-worker's day it would be well below the 5 rem maximum noted in the Department of the Army Pamphlet 385-25, Occupational Dosimetry and Dose Recording for Exposure to Ionizing Radiation. Each organization, for instance NRC, DOD, FEMA, DHS interested in using the invention can have different organizational limits. The health aspects do not change based on the user. However, individual users can have, and some organizations do have, different levels of concern or reporting requirements (e.g. DOE and DOD) so the invention can allow and provide user communication on these dose limits.

Embodiments of the invention can provide the local radiation gradient and health effects at a point. They can provide real-time estimation of the health (or health lost) through integrated measurements of dose and provides dose rate by taking the derivative in time. An example embodiment compares to LD50/30 but not regulations. It can adjust the time between displays based on the last dose rate acquired and automatically determine the timing for the next read. In this way as the dose rate changes so will the sample rate. The technology can incorporate the ability to determine 4p directionality of the radiation flux.

The present invention has been described in connection with various example embodiments. It will be understood that the above descriptions are merely illustrative of the applications of the principles of the present invention, the scope of which is to be determined by the claims viewed in light of the specification. Other variants and modifications of the invention will be apparent to those skilled in the art.

What is claimed is:

1. A radiation-sensing network comprising a plurality of devices, each device comprising (a) one or more radiation sensors, (b) electronic circuitry hardened against radiation and implementing a node on a long range network.

2. The network of claim 1, wherein at least one of the devices collects from a first plurality of devices information corresponding to radiation dose sensed by, and the location of, each device in the first plurality of devices, and produces from such collected information a map representation of a map of the radiation field experienced by the network.

3. The network of claim 2, wherein the at least one device communicates the map representation to other devices on the network.

4. The network of claim 2, wherein at least one of the devices on the network has a capability to communicate the map representation to an internet connection, to a cell phone network, or a combination thereof.

5. The network of claim 2, wherein at least one of the devices presents to a user of the device a hazard representation of a hazard to the user, where the representation of a hazard Is determined from the map representation, from predetermined hazard standards.

6. The network of claim 5, wherein the hazard representation comprises a representation readily interpreted at a glance by a human user.

7. The network of claim 1, wherein the radiation sensors are configured to sense prompt radiation and delayed radiation, and wherein the devices are configured to communicate prompt and delayed radiation to the long range network.

8. The network of claim 1, wherein each device further comprises one or more of a radiation isotope identifier, a Geiger counter, or both.

9. The network of claim 1, wherein each device is configured to remove power from at least portions of the electronic circuitry responsive to sensed radiation exceeding a predetermined harmful threshold.

10. The network of claim 9, wherein each device is configured to restore power responsive to sensed radiation below a predetermined safe threshold.

11. The network of claim 1, wherein each device further comprises a fast response radiation sensor configured to engage a high current shunt to remove power from at least portions of the electronic circuitry responsive to radiation sensed by the fast response radiation sensor that exceeds a predetermined harmful threshold.
